(19) United States
(12) Patent Application Publication
(10) Pub. No.: US 2005/0084781 A1
(43) Pub. Date: Apr. 21, 2005

(54) Manufacturing method for phosphor screen of display tube

(76) Inventors: Wilhelmus Robben, Eindhoven (NL); Ivo Durlinger, Eindhoven (NL); Jan Cromwijk, Turnhout (BE); Edwin Smits, Eindhoven (NL)

Correspondence Address: Philips Electronics North America Corporation, P O Box 3001, Briarcliff Manor, NY, 10510, US

(21) Appl. No.: 10/498,644

(22) PCT Filed: Dec. 2, 2002
(86) PCT No.: PCT/IB02/05106

(30) Foreign Application Priority Data
Dec. 17, 2001 (EP) 0120493.6

(51) Int. Cl. H01J 9/22; H01J 9/227

(52) U.S. Cl. 430/26

(57) ABSTRACT

The invention relates to a method for drying the inside of a CRT-panel after flow coating of, for example, the phosphors while using convection drying with air. The method of the invention is characterized in that the airflow is forced to the corners of the CRT panel, so that the corners are dried much faster. The crux of the invention is the use of a so-called co-rotating barrier plate which covers the CRT-panel and forces the airflow into the corners of the panel. Furthermore, the air used for the drying process can be conditioned on temperature (higher temperature yields a faster evaporation) and on relative humidity (lowering the relative humidity increases the evaporation). The conventional drying of CRT panels is carried out using IR heating elements. In this process especially the corners of the CRT panel take a very long time to dry.

The present invention relates to a method and an apparatus for manufacturing the phosphor screen of a display tube, comprising the steps of:
applying a phosphor slurry in the form of a layer onto the inner surface of a panel held by a support means which is rotatable about an axis;
drying the phosphor layer;
exposing the phosphor layer;
developing the phosphor layer.

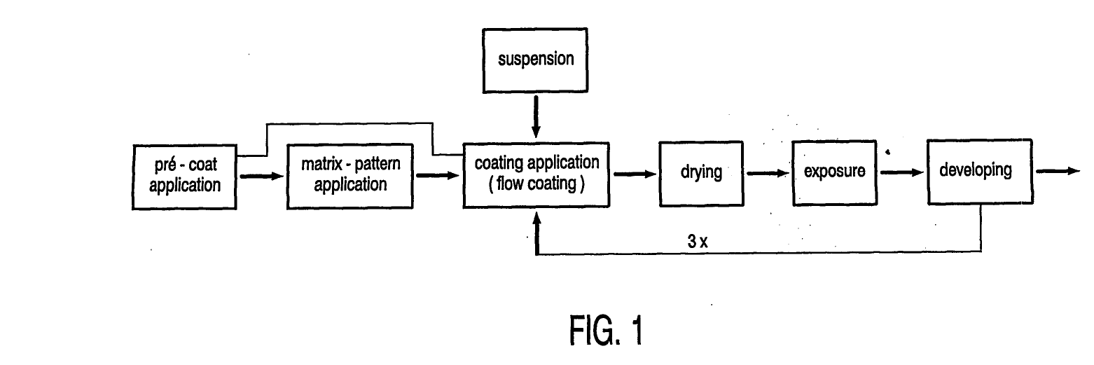

FIG. 1 illustrates a general method in the form of a flow chart for manufacturing the phosphor screen which is formed on the inner face of the panel of a color cathode ray tube, and this method will be described in more detail below.

First a phosphor slurry applying step is carried out in such manner that, while rotating the panel at a proper speed, a proper amount of the phosphor slurry is injected into the inner face of the panel so as for the phosphor slurry to be spread on the whole inner face of the panel, after which the phosphor layer is subjected to a drying stage. Often the drying stage is preceded or interrupted by an excess phosphor slurry recovering step which is carried out in such a manner that the panel is made to spin at a high speed so as for the excess slurry to be recovered.

Thereafter, an exposing step is carried out in such a manner that the phosphor dots of the required pattern are formed on the inner face of the panel through the use of an exposing apparatus and, upon completion of the exposure, the phosphor layer is washed and developed.

The above-described processes are repeated three times in the case that three R, G, B phosphors have to be separately applied.

In such a conventional phosphor screen manufacturing process, a flowcoat mill is used for applying the phosphors. In a current flowcoat process, ⅔ of the flowcoat mill is used to dry the picture area and the panel corners. Especially for larger panel sizes and/or for larger length-to-width ratios, drying of the corners is a bottleneck. For introduction of color filters, the size of the equipment is too large because of the long drying step.

In the above-mentioned process the flowcoat suspension is dosed and the slightly tilted panel is rotated until the layer is settled homogeneously. After spinning to get an even phosphor layer, the screen is rotated to a more or less vertical position to the drying positions. The centrifugal forces, and the inflow from the picture area, force the suspension into the corners. Drying by IR heaters of the picture area is finished fairly quickly, but especially the corners take a very long time to get dry. Moreover, in case of breakdown, the extra longer heat input to the panels causes extra rejects.

In the current process, the heat necessary for the evaporation of the solvent (usually water) is coming from the IR-heaters. The positions of the IR-heaters are fixed.

The panel rotates in a plane in front of the IR-heaters, so that the evaporation solvent is removed by the air movement resulting from the panel rotation.

Therefore, it is an object of the present invention to provide a manufacturing method for the phosphor screen of a color cathode ray tube, which allows faster drying of the corners, preferably in a time which is comparable to the drying time of the picture area of the phosphor screen.

In achieving the above object, the manufacturing method for the phosphor screen of a color cathode ray tube according to the present invention is characterized in that during the drying step heated air is forced to flow toward, and through, each inner corner of the panel by means of an air conveying means which is arranged so as to be stationary relative to the panel.

More specifically, the air conveying means (ACM) is arranged to be co-rotatable with the panel.

According to the present invention, the removal of evaporating liquids is forced by a directed flow of air, and the special characteristic is that the flow is forced towards the corners, so that the corners are dried much faster. The air can advantageously be conditioned on temperature (higher temperature gives faster evaporation) and on relative humidity (lowering the relative humidity increases evaporation).

According to a first embodiment the air conveying means comprises a cover plate which is capable of covering at least the central portion of the open side of the panel.

The cover plate can be designed such that it can bear on the skirt of the panel so that it substantially “closes” the panel.

In a practical embodiment the cover plate has a central air inlet opening for enabling (heated) air to be blown in, and air outlet openings arranged adjacent each inner corner of the panel.

To enable controlled dosing of the air flow, the cover plate is preferably provided with a perforated dosing plate which in operation is located between the cover plate and the phosphor layer.

By arranging the perforated dosing plate at a small distance above the phosphor layer the blown-in air can flow in a controlled manner in the space between the perforated plate and the phosphor layer.

In a further practical embodiment the air conveying means is put into position while the panel is in a substantial horizontal position.

After the ACM has been put into position in the flowcoat equipment, blowing air in and the resulting evaporation of the solvent heed not to start immediately.

Therefore, it is possible to carry out spinning and drying as two separate, sequential steps. Certain artifacts such as the so-called north/south stripes and the 60° cross appear to be reduced by the decoupling of spinning and drying, which is not possible when using the current flowcoating equipment.

Using the above features, the process steps can be as follows:
1) Loading the panel in the flowcoat mill.
2) Dosing of suspension+settling (settling can also be done after “closing” of the panel).
3) Closing the panel by using the co-rotating cover plate.
4) After or during spinning, drying by introducing warm (and dry) air through the air-inlet, the air flowing through the perforated plate which is part of the ACM. The flow of air is mainly towards and through the corners. Additional slits on the sides help to get the corners dry.
5) Just before unloading, the panel can be “opened”.

The above object and other advantages of the present invention will become more apparent by describing in detail the preferred embodiment of the present invention with reference to the attached drawings in which:

FIG. 1 is a flow chart of the manufacturing process for the phosphor screen of a display tube, for example, a color cathode ray tube or a plasma display tube;

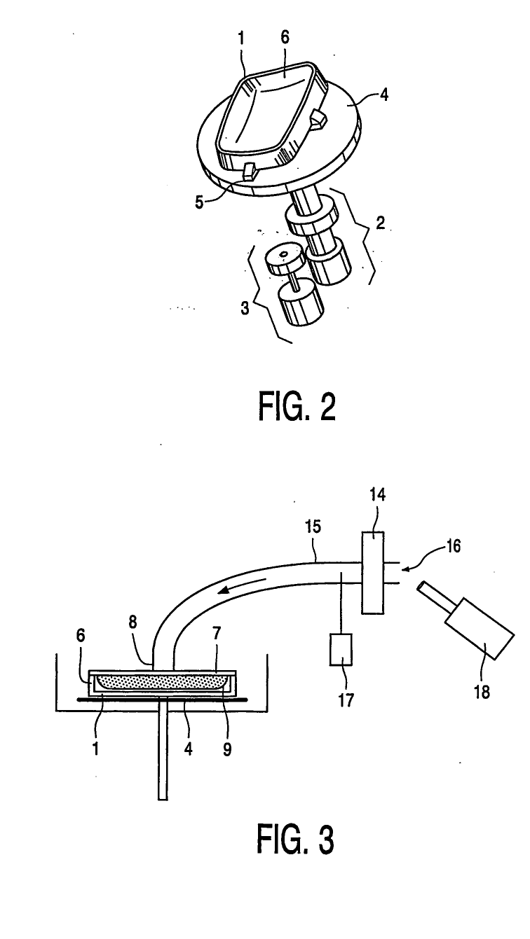

FIG. 2 is a schematic view illustrating a panel of a display tube held in position on a rotatable support means;

FIG. 3 is a schematic sectional view of a phosphor layer drying system used to explain a process according to an embodiment of the invention;

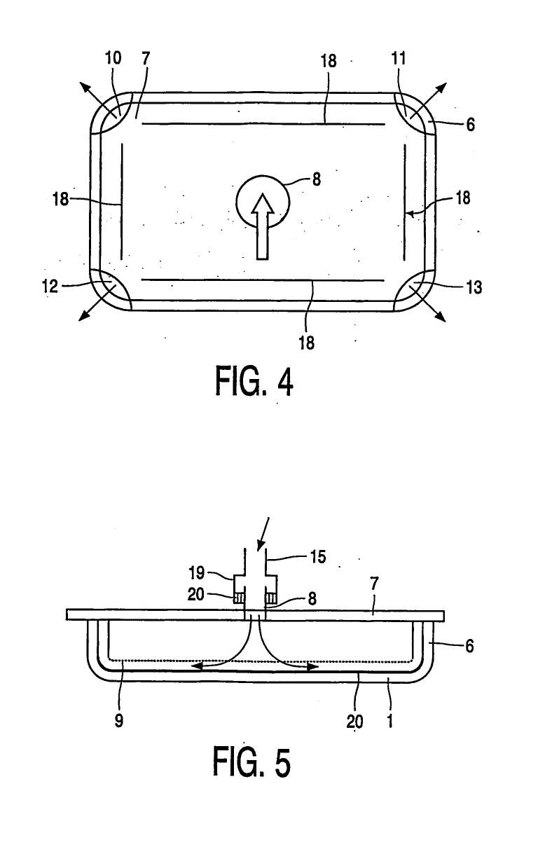

FIG. 4 is a schematic top view of a cover plate for use in the drying system of FIG. 3;

FIG. 5 is a schematic sectional view of a panel provided with an air conveying means used to explain a process according to an embodiment of the invention;

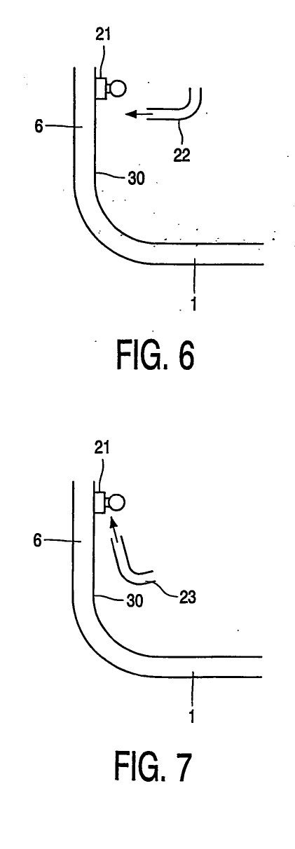

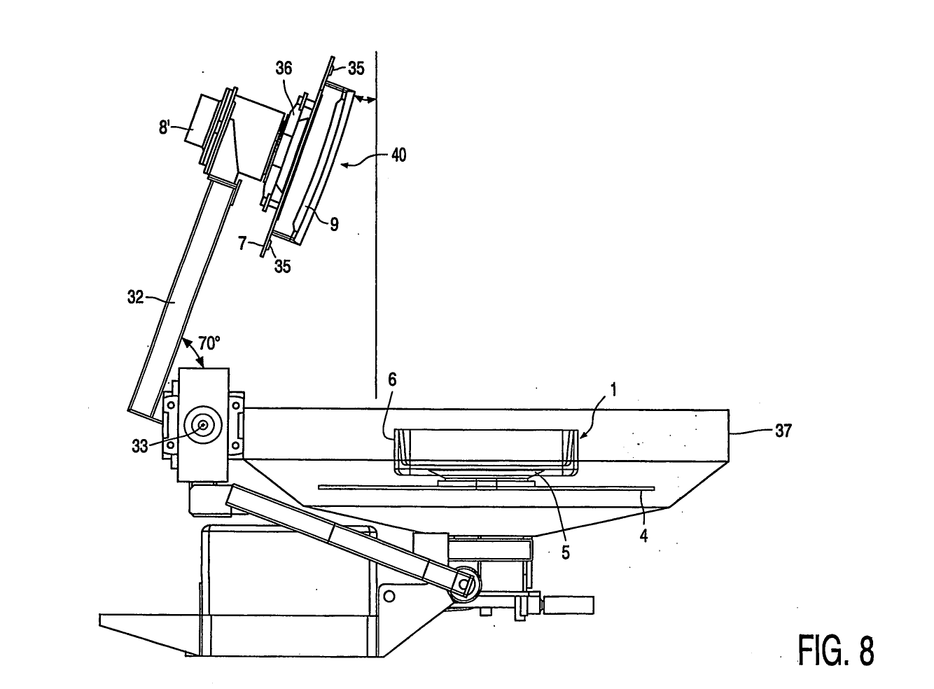

FIGS. 6 and 7 are schematic sectional views of a panel corner used to explain the use of an air-jet, and

FIG. 8 is a schematic view of a part of a flow-coat apparatus equipped with a co-rotatable air-conveying means.

First (see FIG. 1) the inside of the panel (and the associated mask) are thoroughly cleaned. Then the inner face of the panel is covered with a thin coating of PVA, the pre-coat. Next, in the case of matrix screens, the matrix pattern is applied, followed by the application of the phosphors. In the case of ‘non-matrix’ screens the phosphors are applied immediately after the pre-coat.

The phosphors are suspended in water, to which the light-sensitive PVA-ADC system is added. The suspension, first with green phosphor, later with blue phosphor and finally with red phosphor, is poured into the slowly rotating panel and spread evenly.

A next step of the manufacturing process is carried out in such a manner that, with the inner face of the panel directed upwardly in a slightly inclined position, the panel 1, as shown in FIG. 2, is rotated at a low speed, using driving means 2-3, and at the same time a proper amount of the phosphor slurry (suspension) is injected from above. Upon completion of the injection of the phosphor slurry, the panel which is held by panel chucks 5 on a panel support (or table) 4 is made to revolve at a somewhat higher speed so as for the phosphor slurry to be spread over the inner face of the panel. Once the inner face of the panel is covered and the phosphor has had time to sedimentate, the speed increases and the excess suspension is flung out of the screen under the influence of centrifugal forces. All that remains behind is a thin film of suspension. Its thickness is determined by the viscosity of the coating in the vicinity of the glass surface at the moment it is flung out, by the time taken for it to be flung out and by the speed of rotation.

In a drying step the water of the suspension is made to evaporate; this produces a level, dry coating. The above process is known by the name flow coating.

The great heat of evaporation of water is a problem in the application of an even coating of water-based suspension. And the temperature is also of great importance for the photosensitive system. During drying the photosensitive coating may not exceed a temperature of 45° C. because of the occurrence of the so-called ‘dark reaction’.

During the drying of the coating the rate of evaporation of the water must as far as possible be the same all over. The rate of evaporation should not be too high because otherwise the thickening PVA solution cannot flow sufficiently into the porous phosphor coating. The result would be that the residual PVA remains tacky and be the cause of color contamination during the application of subsequent coatings. A compromise has been adopted. The suspension coating is evenly spread by rotating the screen. The applied coating is then dried by controlled heating.

A shadow mask is then placed in the screen which is exposed to the right quantity of light to obtain the required line width (or dot size) and developed.

Developing involves spraying water at the screen, the spraying pressure, the spraying time and the water temperature being the usual variables. After drying, the screen is ready for the application of the next color.

One of the possible solutions in the framework of the invention for faster drying of the wet corners during flow coating is the use of a co-rotating air conveying means or air box (CRAB).

FIG. 3 is a schematic view of the use of such a co-rotating air conveying means.

Panel 1, which has a peripheral skirt 6, is supported by a table 4. Panel 1 has a phosphor layer 20 (FIG. 5) distributed over its inner surface. The air conveying means comprises a cover plate 7 which is arranged directly on (in contact with) the top of the panel skirt 6. The cover plate 7 has a (central) air-inlet (opening) 8. On the panel side of the cover plate 7 a perforated plate is mounted. This can be, for example, a shadow mask. The perforated plate 9 is spanned on both sides (inner and outer side) with a permeable stainless steel sheet in order to create a uniform outflow velocity of the air blown-in through the inlet-opening 8.

As can be seen in FIG. 4, the cover plate 7 has openings 10, 11, 12, 13 for letting the air out adjacent the four panel corners. The airflow streaming out is illustrated by four arrows. Extra slits 18 along the sides of the cover plate 7 may help to force air to flow towards the sides.

A ventilator 14 (FIG. 3) applies air, via a hose 15, to the inlet 8 of the air conveying means. The hose is 15 connected to the inlet 8 by way of a rotatable coupling 19 provided with a sealing 20 (FIG. 5).

The ventilator 14 is controlled by a (frequency) controller. The air velocity flowing through the air conveying means can thus be varied.

A hot air blower 18 is positioned adjacent the ventilator inlet 16 to control the temperature of the air. The air temperature can be measured at the outlet side of ventilator 14 by means of a thermocouple 17.

Several experiments were done using the CRAB device. After suspension dosing (step 1), the screen rotation was stopped to insert the CRAB (step 2). The ventilator and hot air blower are then working; but the air supply is not connected to the CRAB. After arrangement (step 2) the screen rotation resumed. During the subsequent settling phase (step 3) the suspension is distributed over the screen and the phosphor settles. At the end of the settling phase the screen rotational speed is increased to spin off the excess of suspension (step 4). After the spin-off phase the air supply is connected and the drying phase starts (step 5).

In the drying experiments with the CRAB, the air velocity during drying was varied to levels of 0.12, 0.25 and 0.42 m/s.

Satisfactory results were obtained. The drying time was reduced by about 50 to 75% as compared to infra-red drying. However, when drying panels having mask suspension pins arranged in the corners, in some cases suspension drops from the mask pins flow back into the picture area. For increasing air velocities, this effect decreases.

The problem with faster drying of the wet corners is how to prevent the formation of a droplet or a thick suspension layer below the mask pin. Possible solutions to solve this problem could be the following:

Separation of Drying and Spinning

In the current flowcoat program drying and spinning occur at the same time during approximately the first minute of the total drying time. This means that there is still new suspension flowing through the screen corners during drying. By separating spinning and drying, drying is started when the required wet layer thickness has been reached, so no additional flow of suspension occurs during the drying process. If the spinning and drying process can be separated effectively, also all kinds of defects due to combined spinning and drying will disappear.

After spinning off the excess of suspension (step 4), the rotational speed is reduced to, for example, 30 rpm during the drying phase (step 5).

A further improvement can be obtained as follows:

Still making use of separation of dying and spinning, the layer is first dried at a low rotation speed of 30 rpm until the picture area is almost dry and then the rotation is increased to 200 rpm with a high air velocity for the drying of edge and corners. The idea is that the small thick edge is smeared out to a large thin layer due to the high rotation and that drying should then be easier.

Another possibility for solving the wet corner problem is the use of an additional air jet in the corner of the screen beneath the mask pin. This air-jet leads to faster drying rates in the corner and/or the droplet is blown away from beneath the pin.

The application of an air jet directed towards the corner is shown in FIGS. 6 and 7. In a region 1 to 2 cm below the mask pin 21 the suspension is blown away and dried. The used air jet should preferably not be too narrow and not be directed too high.

In FIG. 6 a nozzle 22 is arranged to direct an air jet normal to the corner wall 30.

In FIG. 7 a nozzle 23 is arranged to direct an air jet at an oblique angle towards the corner wall 30; this appeared to improve the effect in certain situations.

FIG. 8 shows more in detail means for bringing the co-rotatable air box in position (in contact with the skirt of the panel) and removing it (=closing and opening of the panel).

FIG. 8 presents an embodiment of a positioning means 31 for bringing a co-rotating air-box (CRAB) 40 towards and from a glass panel 1 which is arranged on a table 4 which forms part of a so-called flow-coat device. Table 4 is provided with a vacuum chuck 5 which keeps panel 1 in position. Table 4 is surrounded by a screen 37. Positioning means 31 comprises a hingeable arm 32, a hinge joint 33 and a holding means 36 for holding the CRAB 40 and an air inlet 8′. The CRAB 40 itself is provided with a cover plate 7 which covers the panel 1 on its open side if it is brought in contact with the upper face of the side wall 6 of the panel 1. In that position the panel skirt and the perforated plate 9 are situated within the panel 1. The arm 32 can be moved, for example, under the action of compressed air. The CRAB 40 may be provided with guiding strips 34 and/or with buffer means 35.

Summarizing, the invention relates to a method for drying the inside of a CRT-panel after flow coating of, for example, the phosphors, using convection drying with air. The method of the invention is characterized in that the airflow is forced to the corners of the CRT panel, so that the corners are dried much faster. The crux of the invention is the use of a so-called co-rotating barrier plate which covers the CRT-panel and forces the airflow into the corners of the panel.

Furthermore, the air used for the drying process can be conditioned on temperature (higher temperature yields a faster evaporation) and on relative humidity (lowering the relative humidity increases the evaporation).

Presently, the drying of CRT panels is carried out using IR heating elements. In this process especially the corners of the CRT panel take a very long time to dry.

1. A manufacturing method for the phosphor screen of a display tube, comprising the steps of:
applying a phosphor slurry in the form of a layer onto the inner surface of a panel held by a support means which is rotatable about an axis;
drying the phosphor layer;
exposing the phosphor layer;
developing the phosphor layer, characterized in that during the drying step heated air is forced to flow toward, and through, each inner corner of the panel by means of an air conveying means which is arranged so as to be stationary relative to the panel.

2. A method as claimed in claim 1, wherein the air conveying means is arranged to be co-rotatable with the panel.

3. A method as claimed in claim 1, wherein the air conveying means comprises a cover plate which is capable of covering at least the central portion of the open side of the panel.

4. A method as claimed in claim 3, wherein the cover plate has a central air inlet opening enabling air to be blown in and air outlet openings arranged adjacent each inner corner of the panel.

5. A method as claimed in claim 3, wherein the cover plate is provided with a perforated dosing plate which in operation is located between the cover plate and the phosphor layer.

6. A method as claimed in claim 1, wherein the air conveying means is put in position while the panel is in a substantially horizontal position.

7. A method as claimed in claim 1, wherein the drying step is carried out during a panel spinning step.

8. A method as claimed in claim 1, wherein the drying step is carried out after a panel spinning step.

9. A method as claimed in claim 1, wherein the air conveying means comprises nozzles arranged to direct an air jet towards each of the inner corners of the panel.

10. A method as claimed in claim 9, wherein in each corner of the panel a mask supporting pin is located, the air jets being directed below each mask supporting pin.

11. An apparatus for manufacturing a phosphor screen on an inner surface of a panel of a display tube, which apparatus comprises a panel support for supporting a rectangular panel having a skirt portion at the periphery thereof, said skirt portion enclosing an opening, and driving means for rotating the panel support about a rotational axis substantially normal to the surface of the panel support, characterized in that the apparatus also comprises an air conveying means which is co-rotatable with the panel support, an inlet opening enabling heated air to be blown in, and means for forcing blown-in air to flow towards, and through, each inner corner of the panel.

12. An apparatus as claimed in claim 11, in which the air conveying means comprises a cover plate which can be positioned so as to substantially cover a panel opening, said cover plate comprising the air inlet opening and an air outlet opening adjacent each panel corner.

13. An apparatus as claimed in claim 11, also comprising means for inclining the rotational axis.
